(19) United States
(12) Patent Application Publication
(10) Pub. No.: US 2005/0203719 A1
(43) Pub. Date: Sep. 15, 2005

(54) Method for simulating reliability of semiconductor device

(75) Inventor: Norio Koike, Kyoto (JP)

Correspondence Address: Jack Q. Lever, Jr.;McDERMOTT, WILL & EMERY LLP, 600 Thirteenth Street, N.W., Washington, DC, 20005-3096, US

(73) Assignee: MATSUSHITA ELECTRIC INDUSTRIAL CO., LTD.

(21) Appl. No.: 10/957,706

(22) Filed: Oct. 5, 2004

(30) Foreign Application Priority Data
Mar. 9, 2004 (JP) 2004-065624

(51) Int. Cl. G06F 17/10

(52) U.S. Cl. 703/2

(57) ABSTRACT

In calculating a substrate current Isub using a substrate current model equation expressed as Isub=(Ai/Bi)·(Vds−Vdsat)·Id·exp (−Bi·lc/(Vds−Vdsat)) (where Id, Vds and Vdsat are drain current, a drain voltage and a saturation drain voltage, respectively, of a MOS transistor, lc is a characteristic length, Ai is a model parameter and Bi is a given constant), the characteristic length lc is a function lc=lc[lc0+lc1·Vgd] (where lc0 and lc1 are model parameters) of a primary expression (lc0+lc1·Vgd) regarding a gate-drain voltage Vgd (=Vgs−Vds: Vgs is a gate voltage of the MOS transistor) of the MOS transistor.

### CROSS-REFERENCE TO RELATED APPLICATION

This application is related to Japanese Patent Application No. 2004-065624 filed on Mar. 9, 2004, whose priority is claimed under 35 USC §119, the disclosure of which is incorporated by reference in its entirety.

### BACKGROUND OF THE INVENTION

The present invention relates to a method for simulating degradation of circuit characteristics caused by hot-carrier degradation in a MOS transistor in a circuit constituted by the MOS transistor. The present invention particularly relates to enhancement of accuracy in the simulation.

As the density and integration level of semiconductor integrated circuit devices have increased and the devices have been miniaturized, the sizes of metal oxide semiconductor (MOS) transistors constituting the devices have been greatly reduced. With this reduction in the sizes of the MOS transistors, especially reduction in the channel length, hot-carrier degradation, which is a large issue in the reliability of the MOS transistors, has become more serious.

This hot-carrier degradation occurs when electrons and holes (which will be correctively referred to as “hot carriers”) with high energy are generated by a high electric field in a drain end of a MOS transistor and these hot carriers causes degradation of properties of a gate oxide film. This hot-carrier degradation has a plurality of degradation modes. Out of these degradation modes, in a degradation mode in which substrate current is at the maximum, drain current decreases with time in both an n-MOS transistor and a p-MOS transistor. This results in an occurrence of degradation, i.e., the delay time of a circuit increases with time. When the increase of the delay time exceeds a certain amount, a timing error occurs during signal input/output operation within a semiconductor integrated circuit or between the circuit and the outside. This causes a malfunction of a whole system in which the semiconductor integrated circuit is incorporated.

On this hot-carrier degradation, a conventional hot-carrier reliability evaluation using an accelerated stress test under a DC condition of a MOS transistor has been performed. In this conventional evaluation, the fabrication process is optimized to meet requirements of the hot-carrier evaluation so that the reliability of products is enhanced.

In recent years, however, the conventional hot-carrier reliability evaluation performed under a DC condition has a difficulty in satisfying the requirements of the evaluation. In view of this, new techniques with which a simulation of hot-carrier degradation in a semiconductor integrated device (hereinafter, referred to as a “circuit reliability simulation”) is performed so as to enhance the reliability of products have been devised. In a circuit reliability simulation, circuit operation after hot-carrier degradation is simulated using a hot-carrier lifetime model and parameters of a circuit simulator SPICE after the degradation based on voltages at terminals and current values in a transistor calculated by the SPICE.

Typical circuit reliability simulators are a BERT (see reference 1, R. H. Tu et al., Berkeley reliability tools—BERT, IEEE Trans. Compt.—Aided Des. Integrated Circuits & Syst., the United States, October 1993, Vol. 12, No. 10, pp. 1524-1534) developed by the University of California at Berkeley or its commercially-available counterpart, BTABERT. These circuit reliability simulation techniques are used to predict a degradation/failure part of a semiconductor integrated circuit so that measures are taken for this predicted part during the design of the circuit. This enables establishment or design of the reliability.

Examples of the method for simulating hot-carrier degradation in a MOS transistor include a method described in reference 2 (Kuo et al., IEEE Trans. Electron Devices, the United States, July 1988, Vol. 35, pp. 1004-1011). A hot-carrier lifetime model used by a circuit reliability simulator for implementing this method has the following features:

Hot-carrier degradation in a MOS transistor is evaluated by using the ratio ΔId/Id of the amount ΔId of a change in drain current to initial drain current Id and other values. Under static hot-carrier stress conditions using direct current (DC), the hot-carrier degradation rate ΔId/Id is expressed by the following equation (1):
ΔId/Id=A·tⁿ (1)
where t is the hot-carrier stressing time, A and n are assumed to be coefficients depending on a fabrication process of a transistor and stress conditions.

Suppose the stressing time until the rate of the change in drain current (i.e., hot-carrier degradation rate) reaches a given value (ΔId/Id)_{f} is transistor lifetime τ, the following equation (2) is derived from equation (1)
(ΔId/Id)_{f}=A·τⁿ (2)

Time t until (ΔId/Id)_{f}=10%, for example, is defined as lifetime τ by using equation (2).

According to reference 2, lifetime τ of a MOS transistor is given by the following Equation (3) regarding an experiment using a hot-carrier lifetime model
τ=((ΔId/Id)_{f})^{l/n}·H·W·Isub^{-m}·Id^{m-1} (3)
where W is the gate width, H is a coefficient depending on conditions for fabricating a transistor, Isub is substrate current and m can be interpreted as an index related to impact ionization and formation of an interface state.

I-V characteristics of a MOS transistor after degradation can be simulated using a ΔId model. Examples of a simulation method using the ΔId model include a method disclosed in reference 3 (Quader et al., IEEE Trans. Electron Devices, the United States, December 1993, Vol. 40, pp. 2245-2254.)

In a ΔId model, degradation amount ΔId of drain current is added to fresh drain current (i.e., initial drain current) before stressing, thereby simulating drain current Id′ after degradation, as expressed by the following equation (4):
Id′=Id(Vds, Vgs)+ΔId(Age, Vds, Vgs) (4)
where Id is a function of drain voltage Vds and gate voltage Vgs, and ΔId is a function of drain voltage Vds and gate voltage Vgs and is also a function of Age. The term Age indicates the amount of stress until time t (hot-carrier stressing time) after the beginning of hot-carrier stressing in a hot-carrier lifetime model. In a physical aspect, Age indicates the total amount of hot carriers with energy which exceeds a critical energy necessary to cause damage on a MOS transistor out of the hot carriers generated until time t.

To calculate Age in a circuit under dynamic stress conditions with alternating current (AC), the following Equation (5), which is an integration regarding time, is used.
Age=∫[(W·H)⁻¹·Isub^{m}·Id^{l-m}]dt (5)
where the integrand in Equation (5) is the reciprocal of a standardized lifetime given by Equation (3).

During the simulation, a SPICE model is used to calculate drain current Id in Equation (3) or (5). As an example of this SPICE model, a Berkeley Short-Channel IGFET Model (BSIM) technique described in, for example, reference 4 (Sheu et al. IEEE J. Solid-State Circuits, the United States, August 1987, Vol. SC-22, pp. 558-566) is used.

During the simulation, a substrate current model is used to determine substrate current Isub in Equation (3) or (5). As an example of the method for calculating substrate current Isub, a method disclosed in, for example, reference 5 (Chan et al. IEEE Electron Device Lett., the United States, December 1984, Vol. EDL-5, pp. 505-507) is used.

This substrate current model is expressed by the following equation (6):
Isub=(Ai/Bi)·(Vds−Vdsat)·Id·exp(−Bi·lc/(Vds−Vdsat)) (6)
where Vds is a drain voltage, Vdsat is a saturation drain voltage, Ai and Bi are constants and lc is the characteristic length. Characteristic length lc is an amount indicating the length of exponential decay of the electric field intensity peak in the drain end and is assumed to be approximately a constant. Specifically, characteristic length lc is approximately expressed by the following equation (7) using gate oxide film thickness Tox and drain junction depth Xj
   Ic=(ε_{Si}·Tox·Xj/εₒₓ)^{1/2} (7)
where ε_{Si} is the dielectric constant of silicon and εₒₓ is the dielectric constant of a silicon oxide film.

The condition necessary for drain junction depth Xj to appear in Equation (7) is that the vertical electric field in the drain end can be disregarded at drain junction depth Xj. An example of a method for deriving Equation (7) is disclosed in reference 6 (Y. Taur et al., Fundamentals of Modern VLSI Devices, the United States, Cambridge University Press, 1998, pp. 154-158.) Characteristic length lc given by Equation (7) is not dependent on the voltages at respective terminals of a MOS transistor. However, in practice, lc is dependent on the voltages at terminals. Therefore, in the circuit reliability simulator BTABERT described above, a model equation for lc having dependence on drain voltage Vds is used as expressed by the following equation (8):
lc=(lc0+lc1·Vds)·(Tox)^{1/2} (8)
where lc0 and lc1 are parameters indicating the dependence of lc on Vds. An example of a substrate current model using Equation (8) is described in reference 7 (BTA Technology, Inc., BTABERT User's Manual Version 2.31, the United States, BTA Technology, Inc., Sep. 12, 1996, pp. 2-1 to 2-3.)

Hereinafter, a method for extracting parameters lc0 and lc1 and constant Ai mentioned above from experimental data will be described specifically.

FIG. 7 is a graph for explaining a method for extracting parameters of a conventional substrate current model from experimental data. Specifically, FIG. 7 is a plot for determining parameters lc0 and lc1 and constant Ai included in Equations (6) and (8) of a conventional substrate current model. In FIG. 7, the ordinate indicates Isub/(Id·(Vds−Vdsat)) obtained by dividing ratio Isub/Id, i.e., the ratio of substrate current Isub to drain current Id, by difference Vds−Vdsat between drain voltage Vds and saturation drain voltage Vdsat using a log scale whereas the abscissa indicates the reciprocal 1/(Vds−Vdsat) of difference Vds−Vdsat between drain voltage Vds and saturation drain voltage Vdsat. Reference numeral 21 denotes data regarding measurement points based on Isub measurement and Id measurement at drain voltages Vds of a MOS transistor. Reference numeral 22 denotes lines fitted to the data regarding the measurement points at drain voltages Vds. Drain current Id and substrate current Isub of a MOS transistor are measured by varying gate voltage Vgs under four drain voltages Vds (=2.3V, 2.7V, 3.1V and 3.5V). In this case, substrate voltage vbs is 0V. From the measurement results on drain current Id and substrate current Isub, saturation drain voltage Vdsat is obtained as a function of gate voltage Vgs. An example of a method for determining saturation drain voltage Vdsat is described in reference 5. Then, Isub/(Id·(Vds−Vdsat)) and 1/(Vds−Vdsat) are obtained for each of the measurement points using saturation drain voltage Vdsat. The results are plotted in the manner that the ordinate indicates Isub/(Id·(Vds−Vdsat)) based on a log scale and the abscissa indicates 1/(Vds−Vdsat).

When the coordinate axes are set in the manner described above, according to Equation (6), the intercepts (y-axis intercepts) of the lines fitted to the data regarding the measurement points are In (Ai/Bi) (where ln is a natural logarithm) and the slopes of the respective lines are −Bi·lc as long as lc and Ai are constant. Accordingly, lc and Ai are obtained from values of ln (Ai/Bi) and −Bi·lc. For data regarding measurement points at drain voltages Vds, parameters lc0 and lc1 and constant Ai in equations (6) and (8) are determined with a method of least squares. Reference numeral 22 in FIG. 7 denotes lines determined by calculation using the parameters thus obtained at drain voltages Vds based on Equations (6) and (8).

FIGS. 8A and 8B are graphs each showing the degree of agreement between the calculated values of substrate current Isub and actually-measured values of substrate current Isub using these parameters. Specifically, FIGS. 8A and 8B show comparison between calculated values of substrate current Isub and actually-measured values of substrate current Isub with Equations (6) and (8) of the conventional substrate current model using drain voltage Vds as a parameter. In FIG. 8A, the ordinate indicates substrate current Isub using a log scale and the abscissa indicates gate voltage Vgs. Reference numeral 23 denotes actually-measured values of substrate current Isub and reference numeral 24 denotes calculated values of substrate current Isub using the parameters determined from the graph shown in FIG. 7 and Equations (6) and (8). In the same way, in FIG. 8B, the ordinate indicates substrate current Isub and the abscissa indicates gate voltage Vgs. Reference numeral 25 denotes actually-measured values of substrate current Isub and reference numeral 26 denotes calculated values of substrate current Isub using the parameters determined from the graph shown in FIG. 7 and Equations (6) and (8).

FIG. 9 is a flowchart showing a procedure of a method for simulating hot-carrier degradation in a circuit using a substrate current model with a conventional technique. The method shown in FIG. 9 includes steps S1 through S4 for making a reliability simulator simulate hot-carrier degradation in a transistor according to Equations (4) through (6) and (8).

First, at step S1, fresh drain current is simulated using transistor parameters before stressing which have been extracted beforehand.

Next, at step S2, substrate current Isub is simulated based on Equations (6) and (8) of the substrate current model, parameters lc0 and lc1 determined by the method described with reference to FIG. 7, and constant Ai.

Then, at step S3, Age, which indicates degradation of a transistor based on Equation (5), is calculated by performing time integration on a function of drain current Id and substrate current Isub in a circuit. In this calculation, drain current Id simulated at step S1 and substrate current Isub simulated at step S2 are used.

Thereafter, at step S4, hot-carrier degradation (specifically drain current Id′ after degradation) in a transistor is simulated using Equation (4) based on Age calculated at step S3.

However, with the conventional method for simulating hot-carrier degradation, the calculation results on substrate current Isub obtained using the conventional substrate current model deviate from the actually-measured values, as shown in FIGS. 8A and 8B. This deviation is large especially when drain voltage Vds is low. Specifically, an accurate simulation of hot-carrier degradation is needed when drain voltage Vds is lower than the voltage during stressing, i.e., is at about a level in actual use. On the other hand, in the conventional substrate current model, deviation is large when drain voltage Vds is low. Consequently, there arises the problem of an error in calculating Age is large at step S3 in the method for simulating hot-carrier degradation in a MOS transistor shown in the flowchart of FIG. 9 and thereby deviation in simulating hot-carrier degradation in the transistor at step S4 is large. This problem causes another problem that application of a technique for simulating hot-carrier degradation is limited.

### SUMMARY OF THE INVENTION

It is therefore an object of the present invention to implement a highly-accurate simulation of hot-carrier degradation widely applicable by creating and using a new high-precision substrate current model.

In order to achieve this object, the present inventor conducted a study to find causes of the lack of precision of a conventional substrate current model, and finally obtained the following findings:

(A) Equation (8) showing dependence of characteristic length lc on a terminal voltage in Equation (6) of a substrate current model used in a conventional method for simulating hot-carrier degradation is merely an approximation of a primary expression regarding only drain voltage Vds and therefore lacks a physical basis.

(B) The assumption that Ai is a constant in Equation (6) has no physical basis.

In view of the findings, the present inventor devised and applied a new substrate current model having a physical basis, to solve the problem of the lack of accuracy in simulating hot-carrier degradation.

Specifically, a method for simulating the reliability of a semiconductor device according to the present invention is a method used to simulate the reliability of a semiconductor device based on a predicted value of a substrate current Isub of a MOS transistor constituting the semiconductor device, wherein in calculating the substrate current Isub using a substrate current model equation expressed as
Isub=(Ai/Bi)·(Vds−Vdsat)·Id·exp(−Bi·lc/(Vds−Vdsat))
(where Id, Vds and Vdsat are drain current, a drain voltage and a saturation drain voltage, respectively, of the MOS transistor, lc is a characteristic length, Ai is a model parameter and Bi is a given constant),
the characteristic length lc is a function lc=lc[lc0+lc1·Vgd] (where lc0 and lc1 are model parameters) of a primary expression (lc0+lc1·Vgd) regarding a gate-drain voltage Vgd (=Vgs−Vds: Vgs is a gate voltage of the MOS transistor) of the MOS transistor.

In the method of the present invention, the function lc [lc0+lc1·Vgd] is preferably proportional to (lc0+lc1·Vgd)^{1/4}.

In the method of the present invention, the model parameter Ai is preferably a function Ai=Ai [lc0+lc1·Vgd] of the primary expression (lc0+lc1·Vgd) regarding the gate-drain voltage Vgd. In this case, the function Ai [lc0+lc1·Vgd] is preferably proportional to (lc0+lc1·Vgd)^{Ai1} (where Ai1 is a model parameter).

According to the present invention, model equations showing dependence on terminal voltages with physical bases are used for lc and Ai in Equation (6) of the substrate current model, so that calculation results on the substrate current less deviate from the actually-measured values. Consequently, hot-carrier degradation in a MOS transistor is simulated with high accuracy. In addition, this simulation of hot-carrier degradation is applicable in a wide range.

As described above, the method for simulating the reliability of a semiconductor device according to the present invention is useful because errors in a hot-carrier simulation for a MOS transistor are reduced when the inventive method is applied to, for example, a method for simulating hot-carrier degradation in a semiconductor integrated circuit.

### BRIEF DESCRIPTION OF THE DRAWINGS

FIG. 1 is an illustration for explaining a physical basis of a substrate current model according to the present invention.

FIG. 2 is an illustration for explaining a physical basis of the substrate current model of the present invention.

FIG. 3 is a graph for explaining a method for extracting, from experimental data, parameters of a substrate current model in a method for simulating the reliability of a semiconductor device according to an embodiment of the present invention.

FIG. 4A is a graph for explaining a method for determining parameters lc0 and lc1 in the method for simulating the reliability of the semiconductor device of the embodiment of the present invention. FIG. 4B is a graph for explaining a method for determining parameters Ai0 and Ai1 in the method for simulating the reliability of the semiconductor device of the embodiment of the present invention.

FIGS. 5A and 5B are graphs each showing the degree of agreement between calculated values of substrate current obtained with the method for simulating the reliability of the semiconductor device of the embodiment of the present invention and actually-measured values of substrate current.

FIG. 6 is a flowchart showing a procedure of the method for simulating the reliability of the semiconductor device of the embodiment of the present invention.

FIG. 7 is a graph for explaining a method for extracting parameters of a conventional substrate current model from experimental data.

FIGS. 8A and 8B are graphs each showing the degree of agreement between calculated values of substrate current obtained with a conventional substrate current model and actually-measured values of substrate current.

FIG. 9 is a flowchart showing a procedure of a method for simulating hot-carrier degradation in a circuit using the conventional substrate current model.

### DESCRIPTION OF THE PREFERRED EMBODIMENTS

Prior to description of a method for simulating the reliability of a semiconductor device according to an embodiment of the present invention, a physical basis of a substrate current model according to the present invention will be described with reference to the drawings and then equations of the substrate current model of the present invention will be described.

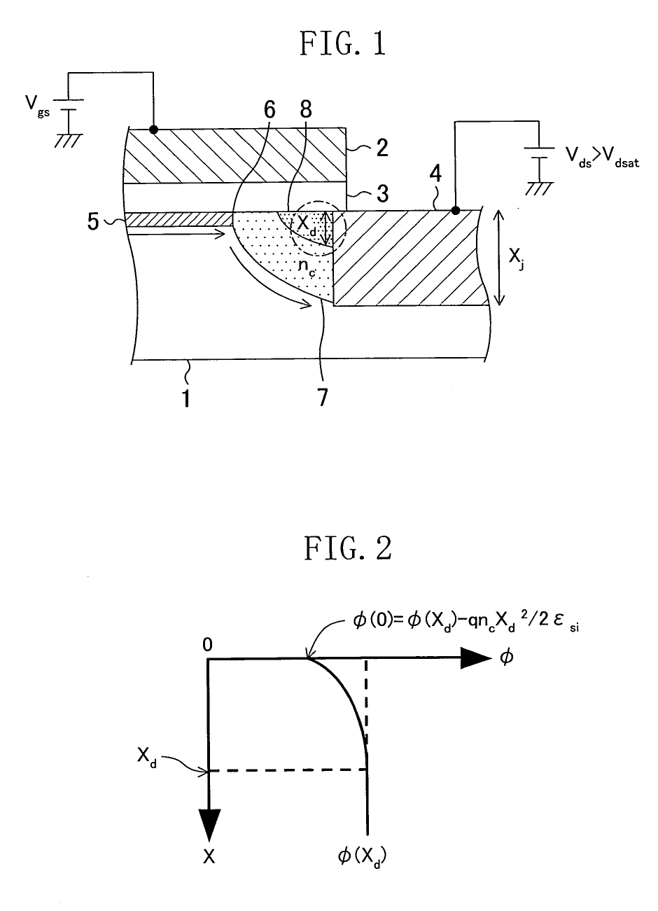

FIG. 1 is an illustration for explaining a physical basis of a substrate current model according to the present invention. Specifically, FIG. 1 shows a distribution of carriers in a drain end of an n-MOS transistor operating in a saturation region. The carriers are electrons in the case of the n-MOS transistor but are holes in the case of a p-MOS transistor. That is, the following description is also applicable to a p-MOS transistor if the type and polarity of carriers, for example, are switched.

As shown in FIG. 1, a gate electrode 2 is formed over a silicon substrate 1 with a gate oxide film 3 interposed therebetween. A drain region 4 is defined in part of the silicon substrate 1 to a side of the gate electrode 2. Gate voltage Vgs is applied to the gate electrode 2. Drain voltage Vds (>saturation drain voltage Vdsat) is applied to the drain region 4.

Carriers in a channel 5 of the MOS transistor operating in the saturation region are predominantly affected by a longitudinal (vertical) electric field until the carriers reach a point 6 where the velocity of the carriers is saturated. On the other hand, the intensity of a lateral (horizontal) electric field in the channel 5 is low, carriers in the channel 5 flow in the surface of the silicon substrate 1, affected by the longitudinal electric field in the gate oxide film 3. However, as the carriers approach the drain region 4, the lateral electric field intensity increases so that the mobility velocity is saturated. In a velocity saturation region extending from the point 6 at which the velocity of carriers is saturated to the drain region 4, carriers flow toward the drain region 4 at a constant saturation velocity Vsat. In this velocity saturation region, the downward longitudinal electric field decreases with increasing proximity to the drain region 4 whereas the lateral electric field increases. Therefore, the electric field intensity in the velocity saturation region exhibits a two-dimensional distribution. As a result, a carrier flow path 7 from the point 6 at which the velocity of carriers is saturated to the drain region 4 extends as deep as drain junction depth Xj from the surface of the silicon substrate 1. In part of the velocity saturation region closer to the drain region 4, the direction of the longitudinal electric field is reversed, thus forming a carrier-depletion region 8.

Drain junction depth Xj appears in Equation (7) of the conventional model regarding characteristic length lc used in Equation (6) of the substrate current model because it is assumed that the depth at which the longitudinal electric field in the drain end can be disregarded is equal to drain junction depth Xj. However, from the consideration based on the carrier distribution in the velocity saturation region, the depth at which the longitudinal electric field in the drain end can be disregarded is not drain junction depth Xj but the depth Xd of the carrier-depletion region 8. This is because the lateral electric field is dominant in the carrier flow path 7 and thus the longitudinal electric field therein can be disregarded. In view of this, in the inventive substrate current model, characteristic length lc is modeled as the following equation (9):
lc=(ε_{Si}·Tox·Xd/εₒₓ)^{1/2} (9)

In the inventive substrate current model, the dependence of lc and Ai in Equation (6) on gate voltage Vgs and drain voltage Vds is modeled as described below. Suppose the carrier density in the carrier flow path 7 is constant in the drain end and this carrier density is n_{c}(/cm³). In addition, suppose the carrier density is approximately zero in the carrier-depletion region 8 and an upward longitudinal electric field corresponding to the charge density equal to the decreased amount of the carrier density, −n_{c}, occurs. This upward longitudinal electric field is generated by positive charge in the drain region 4. Based on these suppositions, the longitudinal electric field in the drain end is expressed by the following equation (10):
Ex(0)=−q·n_{c}·Xd/ε_{Si} (10)
where q is the elementary charge, n_{c} is the carrier density in the carrier flow path 7, Xd is the depth of the carrier-depletion region 8 and ε_{Si} is the dielectric constant of silicon. As described above, the lateral electric field is dominant in the carrier flow path 7 and thus the longitudinal electric field can be disregarded, so that the potential ø in the carrier flow path 7 is constant in the depth direction (i.e., x direction). This potential is equal to that at depth Xd in the carrier-depletion region 8. Suppose this potential is ø(Xd), surface potential ø(0) in the drain end given by Equation (10) is given by the following equation (11):
   ø(0)=ø(Xd)−q·n·n_{c}Xd²/2ε_{Si} (11)

FIG. 2 shows a distribution of the potential in the longitudinal direction in the drain end. As shown in FIG. 2, potential ø in the carrier flow path 7 (where X>Xd) is constant in the longitudinal direction (i.e., depth direction) and is equal to potential ø(Xd) at depth Xd in the carrier-depletion region 8. On the other hand, potential ø decreases with increasing proximity to the surface in the carrier-depletion region 8 (where X≦Xd). Surface potential ø(0) at the surface of the drain end is determined from Equation (11). Difference ø(0)−ø(Xd) between surface potential ø(0) and potential ø(Xd) at depth Xd in the carrier-depletion region 8 in the drain end approximates a primary expression regarding the gate-drain voltage Vgd (=Vgs−Vds). That is, the following equation (12) is established
ø(0)=ø(Xd)−(p0+p1·Vgd) (12)
where p0 and p1 are constants,

If Xd, ø(0) and ø(Xd) are removed from Equations (9), (11) and (12), the following equation (13) is established
lc=[2ε_{Si}³/(εₒₓ²·q·n_{c})]^{1/4}·(p0+p1·Vgd)^{1/4}·(Tox)^{1/2}=(lc0+lc1·Vgd)^{1/4}·(Tox)^{1/2} (13)
where new parameters lc0 and lc1 are introduced. These parameters are respectively expressed by the following equations (14-1) and (14-2):
   lc0=[2ε_{Si}³/(εₒₓ²·q·n_{c})]·p0 (14-1)
   lc1=[2ε_{Si}³/(εₒₓ²·q·n_{c})]·p1 (14-2)

Parameters lc0 and lc1 are expressed using the same symbols as parameters lc0 and lc1 in Equation (8) of the conventional substrate current model but are different from lc0 and lc1 in Equation (8).

As described above, in the inventive substrate current model, lc in Equation (6) is modeled using Equation (13) including parameters lc0 and lc1 given by Equations (14-1) and (14-2), respectively.

On the other hand, in the inventive substrate current model, Ai in Equation (6) is modeled in the following manner. According to a research done by the present inventor, Ai is not such a constant as that used in a conventional technique but a function of the carrier density in the surface of a silicon substrate. The carrier density in the silicon substrate surface is a function of surface potential ø(0), so that Ai is assumed to be a function of gate-drain voltage Vgd and is expressed by, for example, the following equation (15):
Ai=Ai0·(lc0+lc1·Vgd)^{Ai1} (15)
where Ai0 and Ai1 are parameters.

In the method for simulating hot-carrier degradation in a MOS transistor using the substrate current model according to the present invention, Equations (13) and (15) of the inventive model regarding lc and Ai in Equation (6) of the substrate current model are used to simulate hot-carrier degradation.

Hereinafter, a method for simulating hot-carrier degradation in a MOS transistor using the inventive substrate current model, i.e., a method for simulating the reliability of a semiconductor device according to an embodiment of the present invention, will be described.

First, a method for extracting parameters (model parameters) lc0, lc1, Ai0 and Ai1 in the inventive substrate current model from experimental data will be described specifically.

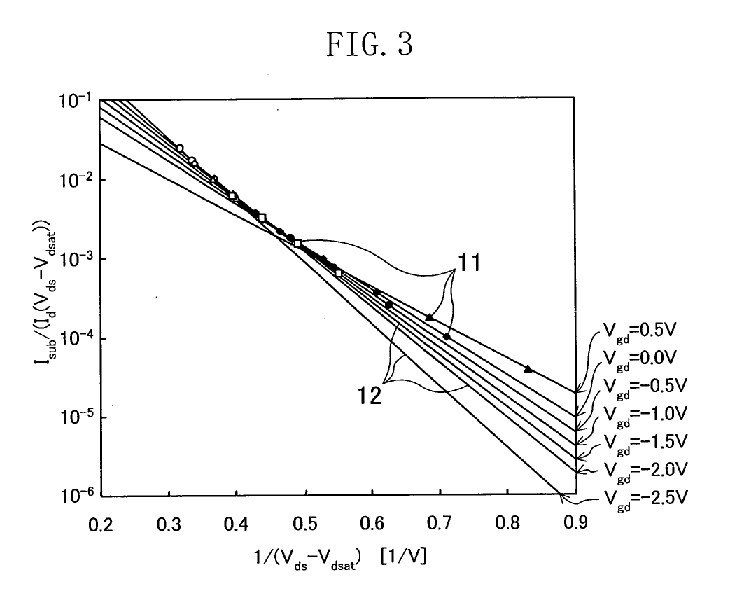

FIG. 3 is a graph for explaining the method for extracting the model parameters of the inventive substrate current model from experimental data. Specifically, FIG. 3 is a plot for determining model parameters lc0, lc1, Ai0 and Ai1 included in Equations (13) and (15) of the inventive model and for showing parameters Ai and lc in Equation (6) of the conventional substrate current model. In FIG. 3, the ordinate indicates Isub/(Id·(Vds−Vdsat)) obtained by dividing ratio I_{sub}/Id, i.e., the ratio of substrate current Isub to drain current Id, by difference Vds−Vdsat between drain voltage Vds and saturation drain voltage Vdsat using a log scale whereas the abscissa indicates the reciprocal 1/(Vds−Vdsat) of difference Vds−Vdsat between drain voltage Vds and saturation drain voltage Vdsat. Reference numeral 11 denotes data regarding measurement points based on Isub measurement and Id measurement at respective gate-drain voltages Vgd (=Vgs−Vds) of a MOS transistor. Reference numeral 12 denotes lines fitted to the data regarding the measurement points at respective gate-drain voltages Vgd. Drain current Id and substrate current Isub of a MOS transistor are measured by varying gate voltage Vgs under four conditions of drain voltage Vds (=2.3V, 2.7V, 3.1V and 3.5V.) In this case, substrate voltage vbs is 0V. From the measurement results on drain current Id and substrate current Isub, saturation drain voltage Vdsat is obtained as a function of gate voltage Vgs. An example of a method for determining saturation drain voltage Vdsat is described in reference 5 mentioned above. Then, Isub/(Id·(Vds−Vdsat)) and 1/(Vds−Vdsat) are obtained for each of the measurement points using saturation drain voltage Vdsat. The results are plotted for each of the gate-drain voltages Vgd such that the ordinate indicates Isub/(Id·(Vds−Vdsat)) based on a log scale and the abscissa indicates 1/(Vds−Vdsat). In FIG. 3, seven gate-drain voltages Vgd, i.e., −2.5V, −2.0V, −1.5V, −1.0V, −0.5V, 0.0V and 0.5V), are plotted for simplicity. However, in practice, the plotting is performed on a wider range of Vgd.

When the coordinate axes are set in the manner described above, i.e., natural logarithms are plotted on the ordinate, according to Equation (6), the intercepts (y-axis intercepts) of the lines fitted to the data regarding the measurement points are ln (Ai/Bi) (where ln is a natural logarithm) and the slopes of the respective lines are −Bi·lc. Accordingly, lc and Ai at gate-drain voltages Vgd are obtained from ln(Ai/Bi) and −Bi·lc. For the data regarding the measurement points at gate-drain voltages Vgd, parameters lc0 and lc1 in Equation (13) and parameters Ai0 and Ai1 in Equation (15) are determined with a method of least squares.

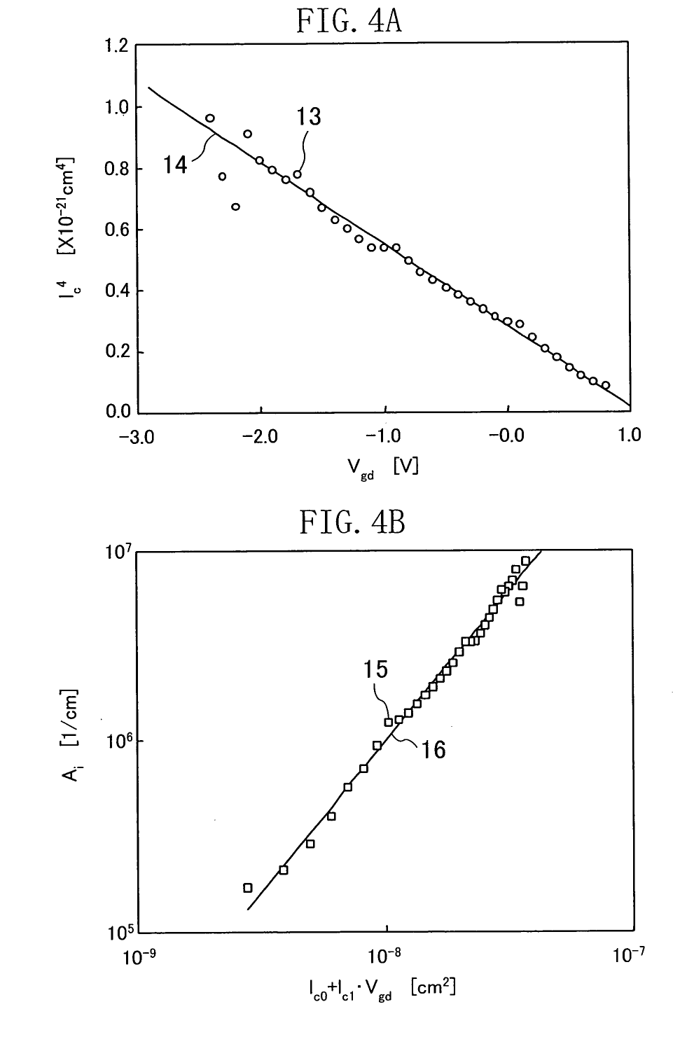

FIG. 4A shows a method for determining parameters lc0 and lc1 in Equation (13) from the data regarding measurement points at gate-drain voltages Vgd by a method of least squares. FIG. 4B shows a method for determining parameters Ai0 and Ai1 in Equation (15) from the data regarding measurement points at gate-drain voltages Vgd by a method of least squares.

In FIG. 4A, data is plotted in such a manner that the ordinate indicates the fourth power of lc (lc⁴) thus obtained with respect to Vgd and the abscissa indicates gate-drain voltage Vgd. In FIG. 4A, reference numeral 13 denotes plotted data and reference numeral 14 denotes a line fitted to the data by a method of least squares. From Equation (13), the intercept (y-axis intercept) of the line 14 is lc0·Tox² and the slope of the line is lc1·Tox² in the plot of “lc⁴” with respect to “Vgd”. Accordingly, lc0 and lc1 are determined from lc0·Tox² and lc1·Tox². Specifically, if a MOS transistor in which the gate oxide film thickness Tox is 5.0 nm is used in this embodiment, lc0=1.13×10⁻⁸ cm² and lc1=−1.07×10⁻⁸ cm²/V are obtained as parameters lc0 and lc1, respectively.

In FIG. 4B, data is plotted in such a manner that the ordinate indicates Ai thus obtained with respect to Vgd based on a log scale and the abscissa indicates (lc0+lc1·Vgd) using parameters lc0 and lc1 thus obtained based on a log scale. In FIG. 4B, reference numeral 15 denotes plotted data and the reference numeral 16 denotes a line fitted to the data by a method of least square. From Equation (15), the intercept of the line 16 is ln (Ai0) (where ln is a natural logarithm) and the slope of the line is Ai1 in the plot of “log scale for Ai” with respect to “log scale for (lc0+lc1·Vgd)”, i.e., in the plot in which natural logarithms are used for both the ordinate and the abscissa. Accordingly, parameters Ai0 and Ai1 are obtained from these values. Specifically, if a MOS transistor in which the gate oxide film thickness Tox is 5.0 nm is used in this embodiment, Ai0=4.60×10¹⁸/cm and Ai1=1.583 are obtained as parameters Ai0 and Ai1.

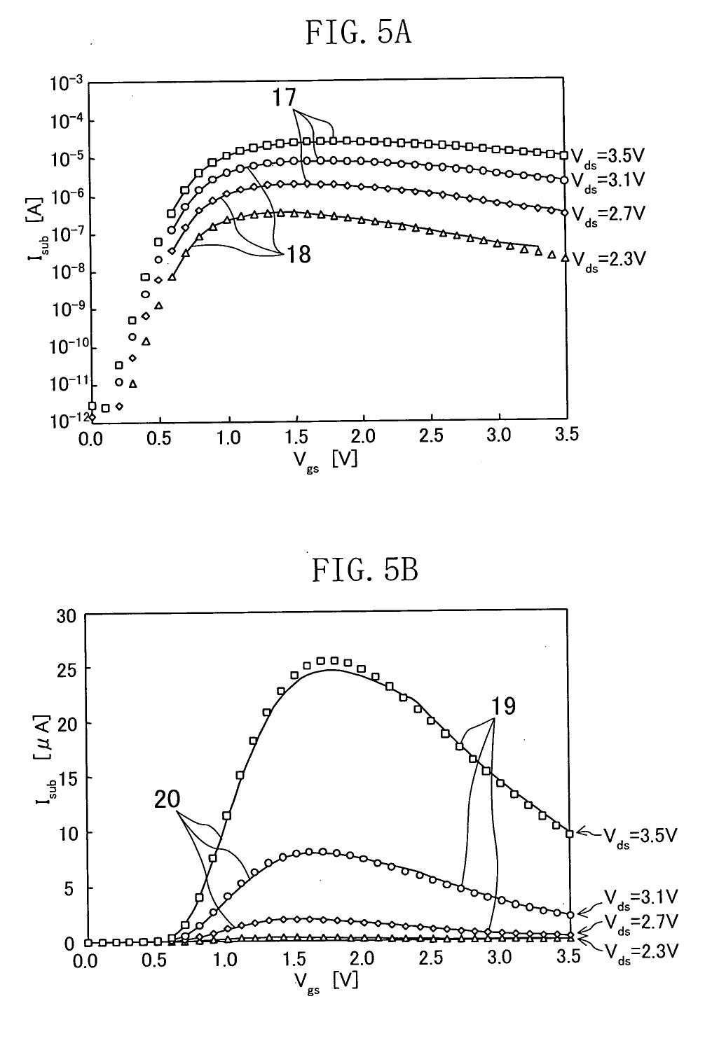

FIGS. 5A and 5B are graphs each showing the degree of agreement between the calculated values of substrate current Isub using the parameters obtained in the manner described above and actually-measured values of substrate current Isub. Specifically, FIGS. 5A and 5B show comparison between the calculated values of substrate current Isub obtained by using Equation (6) of the conventional substrate current model and Equations (13) and (15) of the inventive substrate current model and the actually-measured values of substrate current Isub, using drain voltage Vds as a parameter. In FIG. 5A, the ordinate indicates substrate current Isub using a log scale and the abscissa indicates gate voltage Vgs. Reference numeral 17 denotes actually-measured values of substrate current Isub and reference numeral 18 denotes calculation results on substrate current Isub obtained by using the parameters determined from the graphs shown in FIGS. 3 and 4 and Equations (6), (13) and (15). In the same way, in FIG. 5B, the ordinate indicates substrate current Isub and the abscissa indicates gate voltage Vgs. Reference numeral 19 denotes actually-measured values of substrate current Isub and reference numeral 20 denotes calculation results on substrate current Isub obtained by using the parameters determined from the graphs shown in FIGS. 3 and 4 and Equations (6), (13) and (15).

As shown in FIGS. 5A and 5B, deviation of the calculation results on substrate current Isub in the inventive substrate current model from the actually-measured values is small. This deviation is smaller than that in the conventional substrate current model especially when drain voltage Vds is low.

To determine parameters lc0, lc1, Ai0 and Ai1 in Equations (13) and (15), a method of performing numerical calculation equivalent to the plotting, a method of optimizing parameters by numerical repetitive calculation using a method of nonlinear least squares, or a method in which these methods are combined, for example, can be used, instead of the method of using a plot as described above. If part or the all of the methods for determining parameters lc0, lc1, Ai0 and Ai1 are incorporated in parameter-extracting software as programs, part of or the entire calculation of parameters lc0, lc1, Ai0 and Ai1 can be automated.

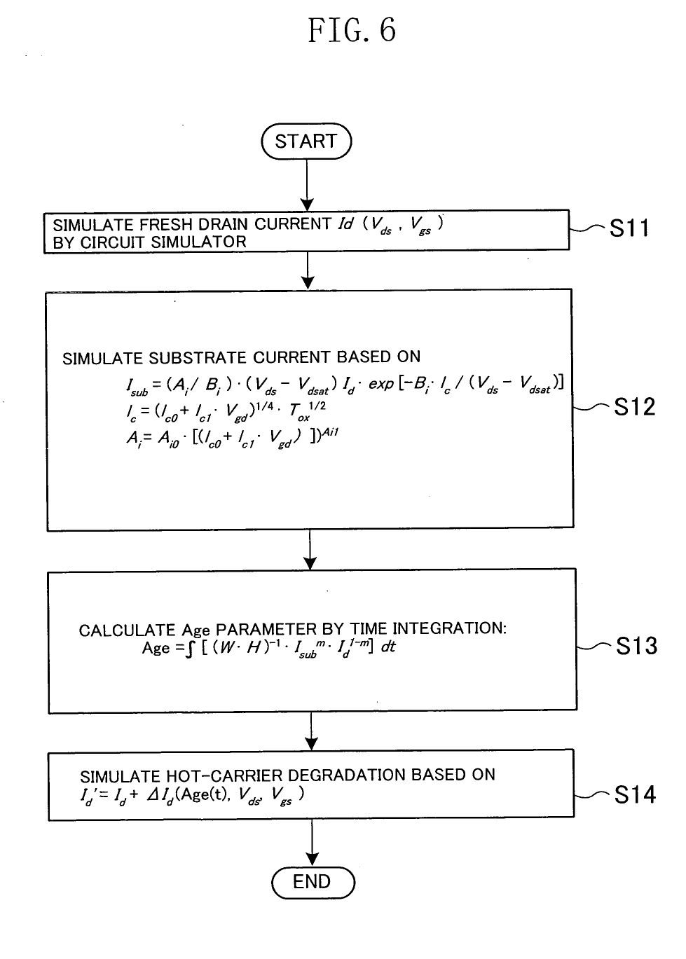

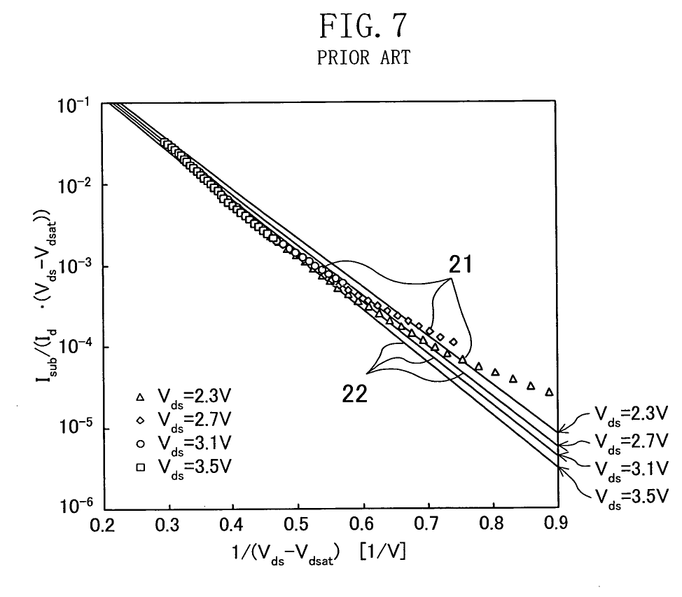

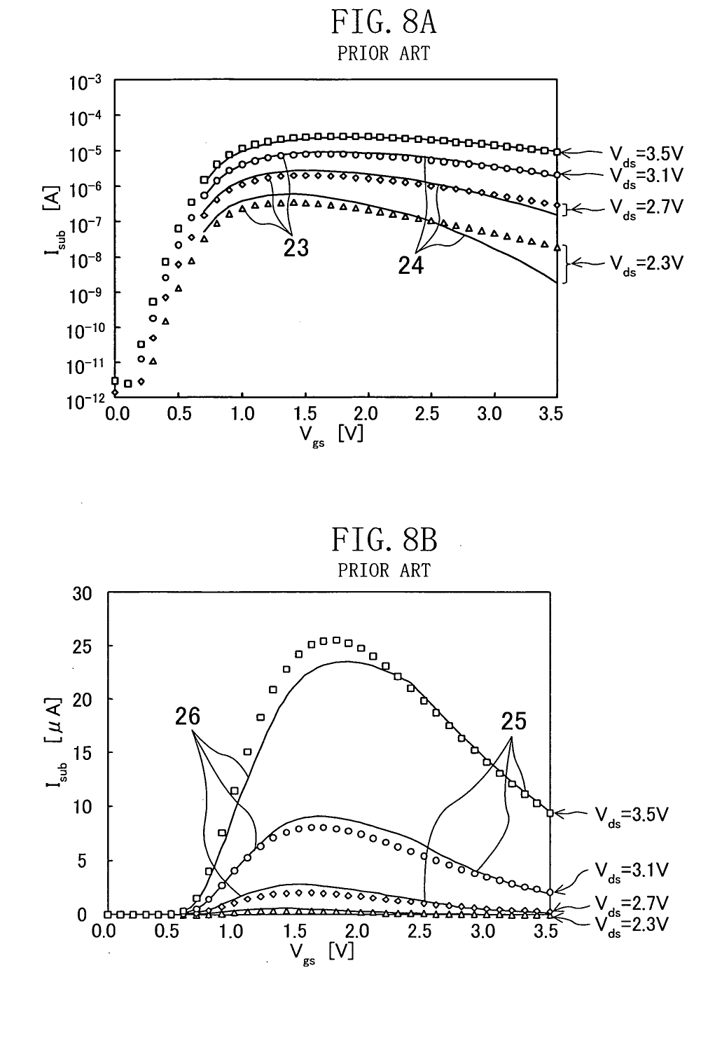

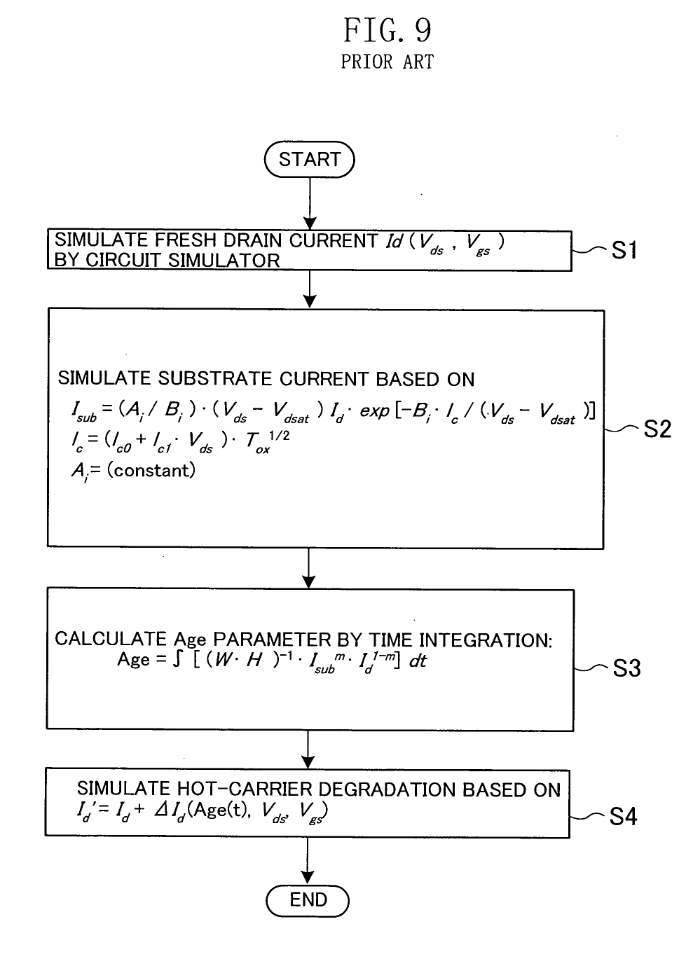

FIG. 6 is a flowchart showing a procedure of a method for simulating hot-carrier degradation in a circuit using the inventive substrate current model, i.e., showing a procedure of a method for simulating the reliability of a semiconductor device according to an embodiment of the present invention. The method shown in FIG. 6 includes steps S11 through S14 for allowing a reliability simulator using a programmed computer, for example, to simulate hot-carrier degradation in a transistor according to Equations (4) through (6), (13) and (15).

First, at step S11, fresh drain current Id is simulated using transistor parameters before stressing which have been extracted beforehand.

Next, at step S12, substrate current Isub is simulated based on Equations (6), (13) and (15) of a substrate current model and parameters lc0, lc1, Ai0 and Ai1 determined by the method described with reference to FIGS. 3 and 4.

Then, at step S13, Age, which indicates degradation of a transistor based on Equation (5), is calculated by performing time integration on the function of drain current Id and substrate current Isub in a circuit. In this calculation, drain current Id simulated at step S11 and substrate current Isub simulated at step S12 are used.

Thereafter, at step S14, hot-carrier degradation (specifically drain current Id′ after degradation) in a transistor is simulated using Equation (4) based on Age calculated at step S13.

As already described above, Equations (13) and (15) of the substrate current model (equations regarding terminal voltage dependence) of the present invention for determining lc and Ai in Equation (6) of the substrate current model shows a function of gate-drain voltage Vgd and has a physical bases, unlike the conventional equation (8) showing dependence of lc on the drain voltage, for example. Accordingly, as shown in FIGS. 5A and 5B, the calculation results on substrate current Isub agree with actually-measured values with high accuracy. The accuracy is higher than that in the conventional substrate current model especially when drain voltage Vds is low.

Specifically, an accurate simulation of hot-carrier degradation is needed when drain voltage Vds is lower than that during stressing, i.e., at about a level in actual use. On the other band, in the substrate current model of the present invention, the accuracy is high when drain voltage Vds is low. Consequently, Age is calculated with high accuracy at step S13 in the flowchart shown in FIG. 6 in the method for simulating hot-carrier degradation in a MOS transistor, resulting in that accuracy in simulation of hot-carrier degradation in a transistor at step S14 is greatly enhanced as compared to a conventional technique. This extends the application range of a technique for simulating hot-carrier degradation.

In this embodiment, as shown in Equation (13), characteristic length lc is expressed using a function which is proportional to (lc0+lc1·Vgd)^{1/4}. Alternatively, another function lc[lc0+lc1·Vgd] of primary expression (lc0+lc1·Vgd) regarding Vgd may be used instead.

In this embodiment, as shown in Equation (15), parameter Ai is expressed using a function proportional to (lc0+lc1·Vgd)^{Ai1}. Alternatively, another function Ai[lc0+lc1·Vgd] of primary expression (lc0+lc1·Vgd) regarding Vgd may be used instead.

1. A method for simulating the reliability of a semiconductor device, the method being used to simulate the reliability of a semiconductor device based on a predicted value of a substrate current Isub of a MOS transistor constituting the semiconductor device,
wherein in calculating the substrate current Isub using a substrate current model equation expressed as
Isub=(Ai/Bi)·(Vds−Vdsat)·Id·exp(−Bi·lc/(Vds−Vdsat))
(where Id, Vds and Vdsat are drain current, a drain voltage and a saturation drain voltage, respectively, of the MOS transistor, lc is a characteristic length, Ai is a model parameter and Bi is a given constant),
the characteristic length lc is a function lc=lc[lc0+lc1·Vgd] (where lc0 and lc1 are model parameters) of a primary expression (lc0+lc1·Vgd) regarding a gate-drain voltage Vgd (=Vgs−Vds: Vgs is a gate voltage of the MOS transistor) of the MOS transistor.

2. The method of claim 1, wherein the function lc[lc0+lc1·Vgd] is proportional to (lc0+lc1·Vgd)^{1/4}.

3. The method of claim 1, wherein the model parameter Ai is a function Ai=Ai [lc0+lc1·Vgd] of the primary expression (lc0+lc1·Vgd) regarding the gate-drain voltage Vgd.

4. The method of claim 3, wherein the function Ai[lc0+lc1·Vgd] is proportional to (lc0+lc1·Vgd)^{Ai1} (where Ai1 is a model parameter).
